(19) United States
(12) Patent Application Publication
(10) Pub. No.: US 2017/0200112 A1
(43) Pub. Date: Jul. 13, 2017

(54) MANAGING A SET OF SHARED TASKS USING BIOMETRIC DATA

(71) Applicant: International Business Machines Corporation, Armonk, NY (US)

(72) Inventors: Su Liu, Austin, TX (US); Eric J. Rozner, Austin, TX (US); Chin Ngai Sze, Austin, TX (US); Yaoguang Wei, Austin, TX (US)

(21) Appl. No.: 14/995,170

(22) Filed: Jan. 13, 2016

(51) Int. Cl. G06Q 10/06; G06F 17/30

(52) U.S. Cl. CPC G06Q 10/063114; G06Q 10/06398; G06F 17/30551

(57) ABSTRACT

Disclosed aspects manage a set of shared tasks. A first set of biometric data which indicates a performance factor for a first user and a second set of biometric data which indicates the performance factor for a second user are detected. Using the first and second sets of biometric data, a set of temporal periods for the first and second users to carry-out the set of shared tasks is determined. The set of temporal periods is selected with respect to carrying-out the set of shared tasks by the first and second users.

### BACKGROUND

This disclosure relates generally to computer systems and, more particularly, relates to managing a set of shared tasks. The amount of shared tasks that needs to be managed by enterprises is increasing. Management of a set of shared tasks may be desired to be performed as efficiently as possible. As shared tasks needing to be managed increases, the need for management efficiency may increase.

### SUMMARY

Aspects of the disclosure relate to scheduling shared tasks based on biometric data. Biometric data may be received from multiple users to identify aspects of an individual user's productivity schedule. A task to be performed by the multiple users can be analyzed to identify rules/standards to positively impact a joint productivity of the multiple users to perform the task. A schedule for the task may be determined based on a predicted impact utilizing weighting for the identified rules/standards.

Aspects of the disclosure manage a set of shared tasks. A first set of biometric data which can be used to derive a performance factor for a first user and a second set of biometric data which can be used to derive the performance factor for a second user are detected. Using the first and second sets of biometric data, a set of temporal periods for the first and second users to carry-out the set of shared tasks is determined. The set of temporal periods is selected with respect to carrying-out the set of shared tasks by the first and second users.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a cloud computing node according to embodiments.

FIG. 2 depicts a cloud computing environment according to embodiments.

FIG. 3 depicts abstraction model layers according to embodiments.

FIG. 4 is a diagrammatic illustration of an example computing environment according to embodiments.

FIG. 5 shows an example system for managing a set of shared tasks according to embodiments.

FIG. 6 illustrates example graphs for managing a set of shared tasks according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to scheduling shared tasks based on biometric data. Biometric data may be received from multiple users to identify aspects of an individual user's productivity schedule. A task to be performed by the multiple users can be analyzed to identify rules/standards to positively impact a joint productivity of the multiple users to perform the task. A schedule for the task may be determined based on a predicted impact utilizing weighting for the identified rules/standards. In embodiments, such rules/standards may be related to productivity, stress, meal times, sleep cycles, shift rotation, alertness, focus, or team goals. In certain embodiments, the schedule may be changed based on real-time data from the users. Also, changes may identify new users, remove users, identify new times, etc.

Aspects of the disclosure include a computer-implemented method, system, and computer program product for managing a set of shared tasks. A first set of biometric data which indicates a performance factor for a first user and a second set of biometric data which indicates the performance factor for a second user are detected. Using the first and second sets of biometric data, a set of temporal periods for the first and second users to carry-out the set of shared tasks is determined. The set of temporal periods is selected (with respect to carrying-out the set of shared tasks by the first and second users). In various embodiments, a user interface is provided allowing an interface user to select and input information including biometric data, suggested meeting times, and prediction rules. Responsive to an interface user utilizing the user interface and selecting/entering input information, the input information may be used to to influence the schedule for the set of shared tasks.

In various environments including a workplace, tasks can be allocated to a team of people over multiple timezones. Team meetings, agile development (e.g., code huddles, scrums), technical talks, or ideation exercises may be scheduled with a plurality of users with geographically diverse work-locations. Circadian rhythm, meal times, or sleep/wake times, for example, can influence productivity with respect to a task. Such biometric characteristics may change for different users across distinct seasons of life (e.g., newborn at home, kids in school, summertime, illness). Wearable devices (e.g., watches, bracelets) may be used to measure/estimate such biometric characteristics. Accordingly, given a multi-person task (e.g., a meeting), biometric data from a wearable device may be used to schedule the task to “get the most out of it” (over all of its participants). As such, meeting times may be scheduled dynamically and be adaptive to the alertness, circadian rhythm, or stress of current or predicted users. Altogether, performance or efficiency benefits when managing a set of shared tasks may occur (e.g., speed, flexibility, resource usage, productivity). Aspects may save computing resources such as bandwidth, processing, or memory.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

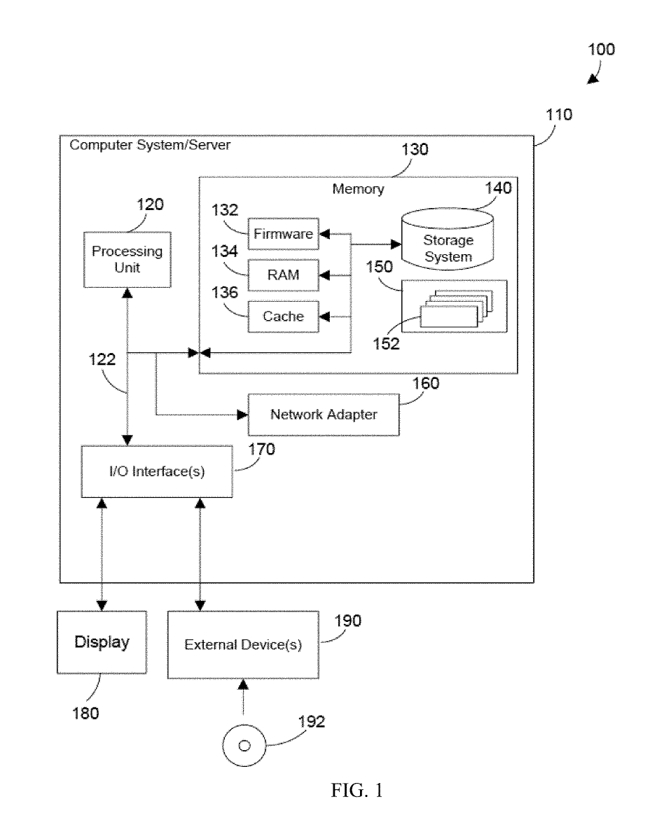

Referring now to FIG. 1, a block diagram of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 110, which is operational with numerous other general purpose or special purpose computing system environments or configurations. Examples of well-known computing systems, environments, and/or configurations that may be suitable for use with computer system/server 110 include, but are not limited to, personal computer systems, server computer systems, tablet computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 110 may be described in the general context of computer system executable instructions, such as program modules, being executed by a computer system. Generally, program modules may include routines, programs, objects, components, logic, data structures, and so on that perform particular tasks or implement particular abstract data types. Computer system/server 110 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 110 in cloud computing node 100 is shown in the form of a general-purpose computing device. The components of computer system/server 110 may include, but are not limited to, one or more processors or processing units 120, a system memory 130, and a bus 122 that couples various system components including system memory 130 to processing unit 120.

Bus 122 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 110 typically includes a variety of computer system readable media. Such media may be any available media that is accessible by computer system/server 110, and it includes both volatile and non-volatile media, removable and non-removable media. An example of removable media is shown in FIG. 1 to include a Digital Video Disc (DVD) 192.

System memory 130 can include computer system readable media in the form of volatile or non-volatile memory, such as firmware 132. Firmware 132 provides an interface to the hardware of computer system/server 110. System memory 130 can also include computer system readable media in the form of volatile memory, such as random access memory (RAM) 134 and/or cache memory 136. Computer system/server 110 may further include other removable/non-removable, volatile/non-volatile computer system storage media. By way of example only, storage system 140 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 122 by one or more data media interfaces. As will be further depicted and described below, memory 130 may include at least one program product having a set (e.g., at least one) of program modules that are configured to carry out the functions described in more detail below.

Program/utility 150, having a set (at least one) of program modules 152, may be stored in memory 130 by way of example, and not limitation, as well as an operating system, one or more application programs, other program modules, and program data. Each of the operating system, one or more application programs, other program modules, and program data or some combination thereof, may include an implementation of a networking environment. Program modules 152 generally carry out the functions and/or methodologies of embodiments of the invention as described herein.

Computer system/server 110 may also communicate with one or more external devices 190 such as a keyboard, a pointing device, a display 180, a disk drive, etc.; one or more devices that enable a user to interact with computer system/server 110; and/or any devices (e.g., network card, modem, etc.) that enable computer system/server 110 to communicate with one or more other computing devices. Such communication can occur via Input/Output (I/O) interfaces 170. Still yet, computer system/server 110 can communicate with one or more networks such as a local area network (LAN), a general wide area network (WAN), and/or a public network (e.g., the Internet) via network adapter 160. As depicted, network adapter 160 communicates with the other components of computer system/server 110 via bus 122. It should be understood that although not shown, other hardware and/or software components could be used in conjunction with computer system/server 110. Examples, include, but are not limited to: microcode, device drivers, redundant processing units, external disk drive arrays, Redundant Array of Independent Disk (RAID) systems, tape drives, data archival storage systems, etc.

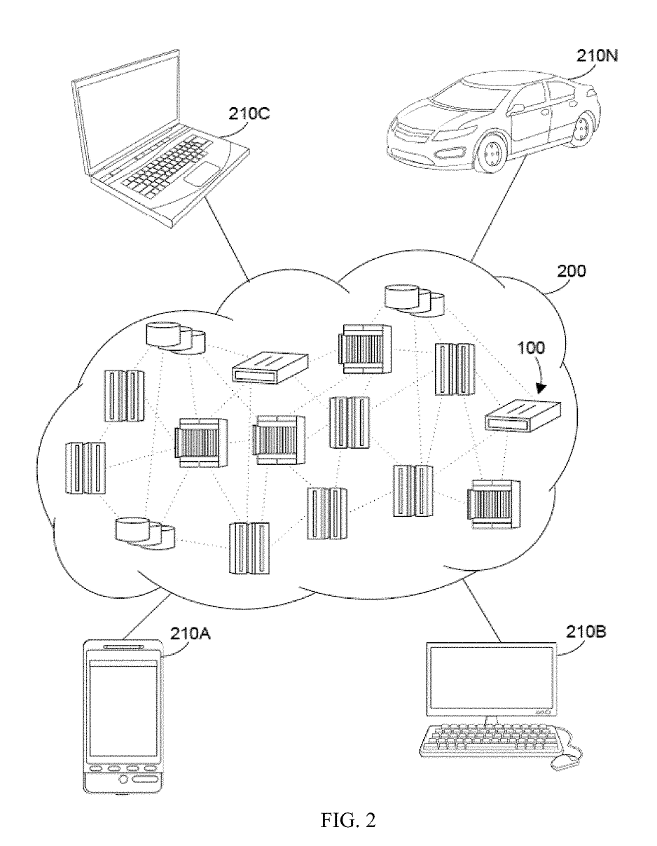

Referring now to FIG. 2, illustrative cloud computing environment 200 is depicted. As shown, cloud computing environment 200 comprises one or more cloud computing nodes 100 with which local computing devices used by cloud consumers, such as, for example, personal digital assistant (PDA) or cellular telephone 210A, desktop computer 210B, laptop computer 210C, and/or automobile computer system 210N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 210A-N shown in FIG. 2 are intended to be illustrative only and that computing nodes 100 and cloud computing environment 200 can communicate with any type of computerized device over any type of network and/or network addressable connection (e.g., using a web browser).

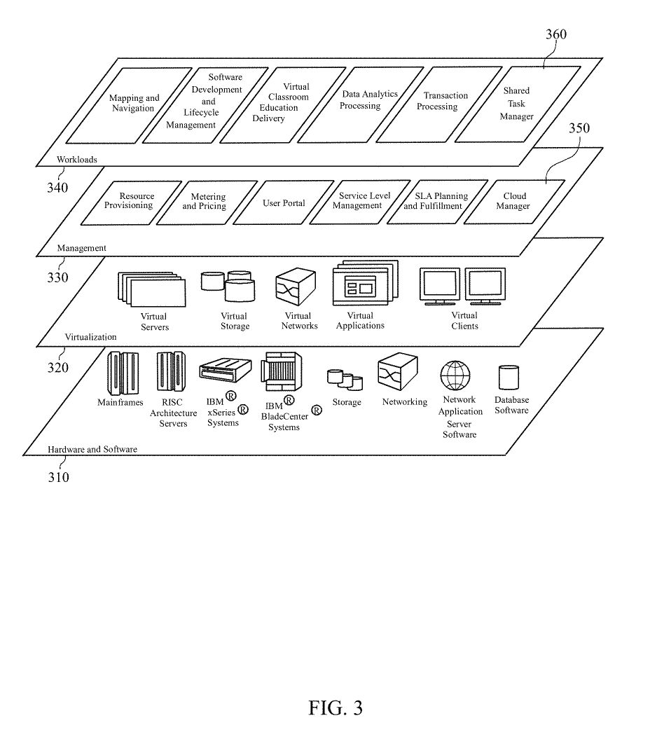

Referring now to FIG. 3, a set of functional abstraction layers provided by cloud computing environment 200 in FIG. 2 is shown. It should be understood in advance that the components, layers, and functions shown in FIG. 3 are intended to be illustrative only and the disclosure and claims are not limited thereto. As depicted, the following layers and corresponding functions are provided.

Hardware and software layer 310 includes hardware and software components. Examples of hardware components include mainframes, in one example IBM System z systems; RISC (Reduced Instruction Set Computer) architecture based servers, in one example IBM System p systems; IBM System x systems; IBM BladeCenter systems; storage devices; networks and networking components. Examples of software components include network application server software, in one example IBM Web Sphere® application server software; and database software, in one example IBM DB2® database software. IBM, System z, System p, System x, BladeCenter, WebSphere, and DB2 are trademarks of International Business Machines Corporation registered in many jurisdictions worldwide.

Virtualization layer 320 provides an abstraction layer from which the following examples of virtual entities may be provided: virtual servers; virtual storage; virtual networks, including virtual private networks; virtual applications and operating systems; and virtual clients.

In one example, management layer 330 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A cloud manager 350 is representative of a cloud manager (or shared pool manager) as described in more detail below. While the cloud manager 350 is shown in FIG. 3 to reside in the management layer 330, cloud manager 350 can span all of the levels shown in FIG. 3, as discussed below.

Workloads layer 340 provides examples of functionality for which the cloud computing environment may be utilized. Examples of workloads and functions which may be provided from this layer include: mapping and navigation; software development and lifecycle management; virtual classroom education delivery; data analytics processing; transaction processing; and a shared task manager 360, which may manage a set of shared tasks as discussed in more detail below.

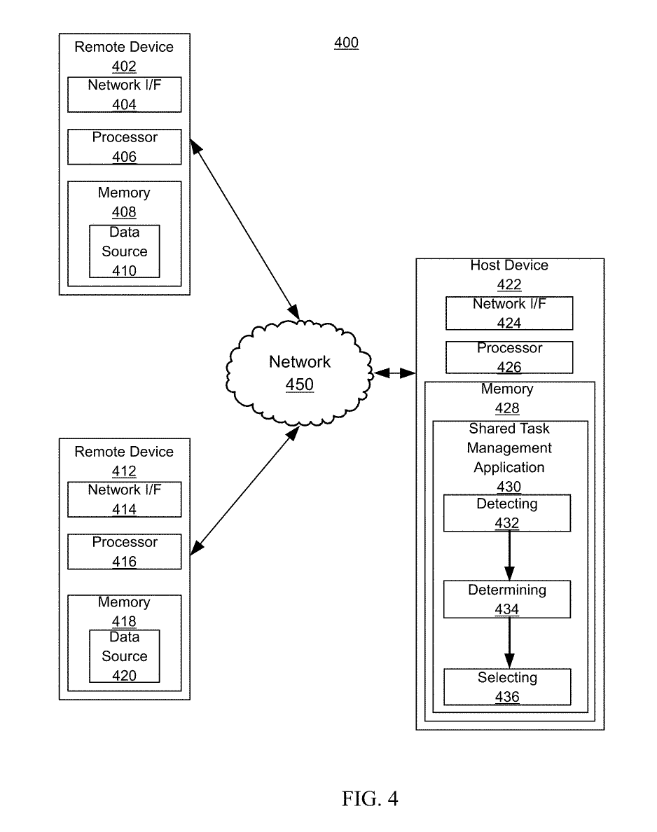

FIG. 4 is a diagrammatic illustration of an example computing environment 400 according to embodiments. In certain embodiments, the environment 400 can include one or more remote devices 402, 412 (e.g., wearable devices) and one or more host devices 422. Remote devices 402, 412 and host device 422 may be distant from each other and communicate over a network 450 in which the host device 422 comprises a central hub from which remote devices 402, 412 can establish a communication connection. Alternatively, the host device and remote devices may be configured in any other suitable relationship (e.g., in a peer-to-peer or other relationship).

In certain embodiments the network 450 can be implemented by any number of any suitable communications media (e.g., wide area network (WAN), local area network (LAN), Internet, Intranet, etc.). Alternatively, remote devices 402, 412 and host devices 422 may be local to each other, and communicate via any appropriate local communication medium (e.g., local area network (LAN), hardwire, wireless link, Intranet, etc.). In certain embodiments, the network 450 can be implemented within a cloud computing environment, or using one or more cloud computing services. Consistent with various embodiments, a cloud computing environment can include a network-based, distributed data processing system that provides one or more cloud computing services. In certain embodiments, a cloud computing environment can include many computers, hundreds or thousands of them, disposed within one or more data centers and configured to share resources over the network.

Consistent with various embodiments, host device 422 and remote devices 402, 412 may include computer systems preferably equipped with a display or monitor. In certain embodiments, the computer systems may include at least one processor 406, 416, 426 memories 408, 418, 428 and/or internal or external network interface or communications devices 404, 414, 424 (e.g., modem, network cards, etc.), optional input devices (e.g., a keyboard, mouse, or other input device), and other commercially available and custom software (e.g., browser software, communications software, server software, natural language processing software, search engine and/or web crawling software, filter modules for filtering content based upon predefined criteria, etc.). In certain embodiments, the computer systems may include server, desktop, laptop, and hand-held devices.

In certain embodiments, remote devices 402, 412 may include a data source 410, 420. The data source 410, 420 may include a database, corpus, or other data storage system configured to communicate with the host device 422. The data source 410 may be configured to provide data (e.g., biometric data which indicates a performance factor such as a productivity factor, a stress factor, a dietary factor, a sleep factor, a shift factor, an alertness factor, a focus factor, or a team goal factor) to the host device 422 for processing. As described herein, the shared task management application 430 of the host device 422 may be configured to manage a set of shared tasks.

The shared task management application 430 may use data/information from one or more data sources such as data source 410 or data source 420. For example, biometric data (e.g., a heart rate, a temperature such as body temperature, a sleep pattern, a glucose value, a blood pressure, a stress score) can indicate or be transformed into a performance factor (e.g., a productivity factor, a stress factor, a dietary factor, a sleep factor, a shift factor, an alertness factor, a focus factor, or a team goal factor). As such, aspects can determine/select a set of temporal periods to efficiently manage/execute a set of shared tasks, for instance. The shared task management application 430 may have a set of operations. The set of operations can include a detecting operation 432, a determining operation 434, or a selecting operation 436.

The detecting operation 432 can include detecting a first set of biometric data which indicates a performance factor for a first user and detecting a second set of biometric data which indicates the performance factor for a second user. Detecting may include receiving, sensing, retrieving, collecting, or scanning and identifying. The performance factors can have normalized units (e.g., biometric conversion units) to permit usage, functionality, or comparisons across a plurality of users or biometric data types (e.g., with respect to temporal periods such as time of day). For instance, biometric data such as a glucose value (e.g., 175 mg/dL) and a blood pressure (e.g., 160 over 100 millimeters of mercury) may be detected to indicate a stress factor (e.g., 90 on a scale of 0 to 100) which is relatively high for a given user immediately after lunch on a Monday. As such, the stress factor may indicate to avoid scheduling a shared task (e.g., a meeting that the given user is a principal subject matter expert) for that time-period. Similarly, a sleep pattern of a certain user can be detected to indicate that the certain user generally is lacking sleep and may be tired on a Friday (e.g., at least relative to the certain user on a Monday). Also, the certain user's circadian rhythm may be detected to indicate that the certain user is generally highly alert at 6:30 am and generally less alert at 4:30 pm. As such, the certain user may be scheduled to operate/drive as a member of a car pool on Monday mornings but not on Friday afternoons based on a shift/sleep factor.

The determining operation 434 may include determining, computing, or formulating a set of temporal periods (e.g., time slots such as 1 pm to 2 pm) for the first and second users to carry-out or execute the set of shared tasks using the first and second sets of biometric data. The set of temporal periods may be computer-generated, a user input (e.g., 1 day, 1 hour, 20 minutes), or a predetermined time-to-live value (e.g., 45 minutes after an event). The carrying-out/execution may be performed jointly (e.g., multiple individuals in one meeting) or separately (e.g., a first sub-task by a first user at a first time and a second sub-task by a second user at a second time). Biometric data may be used to calculate, compute, formulate, or map-to performance factors or specific performance factor values (e.g., a resting heart rate of 50 beats per minute for a 25 year old man may map-to a stress factor of zero). In various embodiments, biometric data can be directly used to determine the set of temporal periods (e.g., based on heart rate of users rather than also extrapolating to a stress factor).

The selecting operation 436 can include selecting the set of temporal periods (with respect to carrying-out the set of shared tasks by the first and second users). Selecting can include, for example, storing a data value (e.g., entering a digit/character in a database), transmitting a data object (e.g., sending an object having metadata), routing a message (e.g., publishing a time-period as closed), or providing/performing/processing an operation (e.g., a notification). For example, selecting can include changing a data value from a 0 to a 1 to indicate that 9 am to 10 am will be used for a basic skills test in a classroom in response to both detecting biometric data of the students and determining that the cognitive ability of students in the classroom is above a threshold (e.g., in the top 10% of one hour periods during the day). As another example, practice times for indoor athletic facilities may be scheduled, messages routed, and notifications provided such that the tennis team practices early in the morning and the baseball team practices late at night based on circadian rhythm of the starting athletes (e.g., weighting starters/top-performers more so than backups/reserves). In certain embodiments, when various athletes have educational conflicts, the data may change dynamically so-as to adjust practice times.

The shared task management application 430 may provide performance or efficiency benefits for managing a set of shared tasks. For example, aspects may include positive impacts on network utilization or workload productivity. Altogether, performance or efficiency benefits may occur (e.g., speed, flexibility, responsiveness, resource usage).

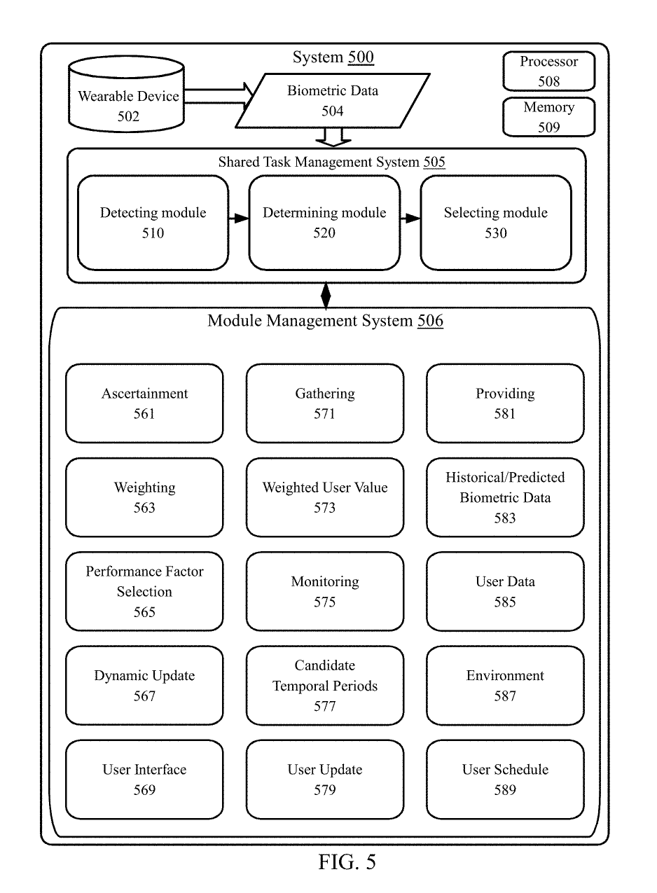

FIG. 5 shows an example system 500 for managing a set of shared tasks according to embodiments. The example system 500 includes a (computer/hardware) processor 508 and a memory 509. The example system 500 may be associated with a wearable device 502 and has biometric data 504. The wearable device 502 may be used to track/collect a user's biometric information. The biometric data 504 may be used for operation(s) with respect to aspects described herein including the shared task management application 430.

The example system 500 can include a shared task management system 505. The shared task management system 505 may include a detecting module 510 (see e.g., description with respect to operation 432 of FIG. 4), a determining module 520 (see e.g., description with respect to operation 434 of FIG. 4), and a selecting module 530 (see e.g., description with respect to operation 436 of FIG. 4). As such, the example system 500 may implement aspects of the shared task management application 430. In embodiments, other aspects may be included such as a module management system 506 which can have a set of modules.

Ascertainment module 561 may ascertain the performance factor. The first user can have a first performance factor value (e.g., a numerical value) for the performance factor. Likewise, the second user can have a second performance factor value for the performance factor. In embodiments, a confidence level may be used to indicate a degree of certainty in converting a biometric unit to a productivity unit (e.g., if a user has an extremely high heart rate exceeding a threshold the system may be very confident that the user is stressed, if a user slept 5 hours instead of a normal 7 hours then the system may have low confidence that the user is stressed).

To identify a set of criteria (e.g., time-slots, event responses, ordering of events, user involvement) which favors productivity for the first and second performance factor values, the set of shared tasks may be analyzed. Data analysis may include a process of inspecting, cleaning, transforming, or modeling data to discover useful information, suggest conclusions, or support decisions. Data analysis can extract information/patterns from a data set (e.g., the set of shared tasks) and transform/translate it into an understandable structure (e.g., a data report which can be provided/furnished) for further use. In response to analyzing the set of shared tasks, the performance factor may be ascertained based on the set of criteria. For example, healthcare workers (e.g., nurses) may be scheduled for certain shifts or appointments based on their expected productivity as measured by energy level values/scores. The data analysis may inspect each worker's energy level at various times of the day (e.g., early morning, late afternoon) or after various events (e.g., after surgery, before clinic) and an ascertainment algorithm with various thresholds (e.g., to have at least a minimum level present for a given duty) may be used to place the workers in certain shifts/appointments.

Weighting module 563 may weight the first and second performance factor values. Weighting may be performed based on an attribute value of the first user exceeding the attribute value of the second user. For example, the first user may be the manager, organizer, and subject matter expert of a project whereas the second user may be an assistant to an assistant of a small portion of the project. In other examples, a higher ranking individual (e.g., vice-president) may be weighted less than that of a regular staff member (e.g., engineer) for the project because the higher ranking individual may be there to attend as a listen-only person whereas the regular staff member may be in charge of giving a presentation. Accordingly, the attribute value may be related to company ranking, experience, years of service, subject matter expert status, project leadership, project staff, project management, contribution amount (e.g., percentage of slides or white-paper drafted), authorship, etc. In various embodiments, a first difference (e.g., 450−50=400) between a weighted first performance factor value (e.g., 9×50=450) and the first performance factor value (e.g., 50) exceeds a second difference (e.g., 200−50=150) between a weighted second performance factor value (e.g., 4×50=200) and the second performance factor value (e.g., 50). In various embodiments, the weighting may be user-defined (e.g., based on user input values).

Performance factor selection module 565 can include choosing one or more performance factors. A productivity factor can include output or expected output based on, for instance, circadian rhythm or energy level. A stress factor can include measurements taken before work, at work when working with certain people, at work when working alone, or after work. A dietary factor can include meal times, nutrition, calorie quantity, calorie quality, etc. A sleep factor can include sleep duration, sleep quality, sleep quantity relative to a threshold, single-day measurements, multiple-day measurements, etc. A shift factor can include operator/work-shift placement, operator/work-shift quantities over a period of time, extended operator/work-shifts, bunched operator/work-shifts, etc. An alertness factor can include a caffeine score, a sugar score, a pupil-size score, a hearing score, an eye-gaze score, etc. A focus factor can include a concentration score, an environment distraction score (e.g., music, radio, television, children), a sensitivity score, etc. A lactate factor can relate to a lactate threshold which may include a point during exercise at which lactic acid accumulates in an individual's blood stream faster than the individual's body can get rid of it. A team goal factor can include a unity score, an achievement score relative to a threshold, a predetermined quantity, etc. Such factors are provided as examples, other factors are contemplated.

Dynamic update module 567 can utilize dynamic or real-time information to influence aspects such as the set of temporal periods. In certain embodiments, a dynamic update may be received in response to determining the set of temporal periods. The dynamic update may indicate a status change (e.g., stress level dips below a threshold), information adjustment (e.g., glucose level movement), contextual shifts (e.g., a particular attendee indicates cancellation of their attendance to a meeting thereby affecting others), or other user/environmental factors (e.g., location). For example the dynamic update may include a biometric data update to at least one of the first set of biometric data or the second set of biometric data, a user update which adds a new user or removes an existing user, or a candidate temporal period update which adds or removes a candidate temporal period from which to select the set of temporal periods. Based on the dynamic update, the set of temporal periods may be changed (e.g., determining a new/different time slot for the set of shared tasks). For instance, a mission originally scheduled for 10 pm may be changed to 2 am based on a weather event (e.g., lightning strikes), or a group of personnel arriving later due to unexpectedly delayed travel. As another example, a meeting may be rescheduled in response to a stressful event within a threshold period of time prior to the meeting (e.g., a highly-weighted user such as the meeting leader/organizer being involved in a car accident within two hours of the meeting).

User interface module 569 can provide a graphical user interface to an interface user/individual. The user interface may allow the interface user to supply information including biometric data (e.g., a pulse, circadian rhythm), suggested meeting times (e.g., 10 am or 1 pm), or prediction rules (e.g., if a threshold percentage of meeting invitees have a circadian rhythm which indicates morning is more productive for them than after lunch then choose a morning meeting rather than using other factors, if up-to-date biometric data is missing for a group of staff members due to them being out of the country on travel then use their historical data from previous times they returned from travel rather than disregarding data for them). In response to the interface user utilizing the user interface, the set of temporal periods may be determined using the supplied information. For example, the interface user may provide a mandate that a particular operator runs/drives/pilots a vehicle/machinery at a given time slot and the computer system may choose the remaining time slots for operation of the vehicle/machinery in an automated fashion without user intervention.

Gathering module 571 can collect and store biometric data. Using a first electronic wearable device (e.g., smartwatch, bracelet, headband), the first set of biometric data for the first user is collected. Using a second electronic wearable device, the second set of biometric data for the second user is collected. Storage may then occur on a shared pool of configurable computing resources which has both a first physical compute node and a second physical compute node. The second set of biometric data may be stored on the second physical compute node which is physically separate from the first physical compute node where the first set of biometric data may be stored on (e.g., distributed storage for performance/efficiency benefits such as information security). For example, healthcare information may be stored on separate servers (e.g., in different time zones) within a cloud environment. In various embodiments, the first and second sets of biometric data may be stored in a central repository (e.g., for performance/efficiency benefits such as network bandwidth usage). For instance, game/match schedules for a sports tournament (e.g., youth soccer) may be stored on one computer in a cloud environment.

Weighted user value module 573 may utilize calculated weighted user values to determine the set of temporal periods. Based on a first user profile data (e.g., user role/importance, user history, user biometrics, user busyness) and the set of shared tasks (e.g., substantive matter involved), a weighted first user value can be calculated for carrying-out the set of shared tasks (e.g., by multiplying a score from the profile data by a score from the shared tasks). Similarly, based on a second user profile data and the set of shared tasks, a weighted second user value can be calculated for carrying-out the set of shared tasks. In response to calculating the weighted first and second user values, the set of temporal periods may be determined. The determination can use both the weighted first user value with respect to the first set of biometric data and the weighted second user value with respect to the second set of biometric data. For example, a baseball pitcher may have a high weighted user value for days when the baseball pitcher has a turn in a rotation to throw live in practice but have a low weighted user value on the baseball pitcher's conditioning day. Biometric data (e.g., muscle mass) may be used to determine which of a group of baseball pitchers should do pitcher's fielding practice (e.g., for some it may be on live throwing day while for others it may be on conditioning day).

Monitoring module 575 may monitor a user to capture/collect a dynamic update. The first user may be monitored to collect a first dynamic update to the first set of biometric data. In embodiments, monitoring may occur in response to determining the set of temporal periods. Also, the second user may be monitored to collect a second dynamic update to the second set of biometric data. Using on the first and second dynamic updates the set of temporal periods may be evaluated with respect to a candidate temporal period (which is indicated by at least one of the first dynamic update or the second dynamic update). As such, the dynamic update may provide a high performing or more efficient temporal period to perform the set of shared tasks. Thus, with respect to carrying-out the set of shared tasks by the first and second users, the candidate temporal period may be selected. For instance, a spelling test may be originally scheduled at 9:30 am in order to wait for a particular student to recover more fully from being at the dentist early in the morning. In response to an update that the particular student is ill and will not be attending class, the spelling test may be rescheduled for 9 am so as to permit extra recess time at 10 am.

Candidate temporal periods module 577 can compute/provide a set of candidate temporal periods. The set of candidate temporal periods (e.g., options for time slots) may be computed using the first and second sets of biometric data which indicate the performance factor for the first and second users. The set of candidate temporal periods may be provided (e.g., presented, displayed) for selection by an interface user. For example, a multidimensional array of possible truck-driving operators and shifts may be computed and presented to a truck-company manager for selection of the management preferred operators and shifts. As such, various arrangements which may be similarly efficient can allow for a tiebreaker process by management based on factors not input into the system.

User update module 579 may perform an operation related to a user update to a group of users (which includes the first and second users). The group of users may be monitored to identify a user update. The user update can include adding a new user (e.g., a third user) or removing an existing user (e.g., the second user, the third user). In certain embodiments, the user update may include changing a user's profile data. In embodiments, the monitoring may occur in response to determining the set of temporal periods. Based on the user update, the set of temporal periods may be evaluated with respect to a candidate temporal period which is indicated by the user update. Accordingly, the candidate temporal period can be selected to carry-out the set of shared tasks (e.g., replacing the set of temporal periods in response to the evaluation). For example, the user update may include changing individual healthcare practitioners for specified appointments/tests/events. As such, time slots for the appointments/tests/events may be altered consistent with the changes in individual healthcare practitioners.

Providing module 581 can provide (e.g., present, display) an arrangement of the set of temporal periods or the set of candidate temporal periods. The arrangement may be provided for selection of a set of temporal periods by an interface user. In embodiments, the arrangement can be provided in response to determining the set of temporal periods. The set of temporal periods may be arranged based on an expected productivity score (e.g., ranking/ordering/sorting the temporal periods by predicted performance/efficiency) that relates to both the first and second sets of biometric data and the first and second users. For instance, a set of potential meeting time slots may be presented (e.g., with the more predicted efficiency time slots being displayed larger than the less predicted efficiency time slots) to an interface user for selection.

Historical/predicted biometric data module 583 can make-up-for corrupted, missing, or unavailable biometric data using historical/predicted biometric data. Aspects can be included when detecting a particular set of biometric data which indicates the performance factor for a particular user. A disconnection may be sensed with respect to a dynamic connection (e.g., real-time linkage) related to a particular set of dynamic biometric data for the particular user. A set of historical biometric data for the particular user or a set of predicted biometric data for the particular user may be received (e.g., to make-up-for other biometric data). The historical/predicted biometric data may be sent/transmitted from a shared pool of configurable computing resources in response to sensing the disconnection. The set of historical biometric data can be received (e.g., at the cloud). The set of historical biometric data can be used to help predict the biometric data for a user. Other mechanisms may be available to predict the biometric data of a user besides history, such as biometric data from other individuals that have biometric factors which correlate (e.g., correlate above a threshold) to the user in the past (e.g., use a relative's information such as a spouse or sibling). For example, if biometric data is missing for a subset of students preparing to take an exam, historical data with the respect to the subset of students may be utilized.

User data module 585 may receive a set of user data. The set of user data may be received from an interface user via a user interface. The set of user data may include a set of preferred temporal periods (e.g., preferences input by the interface user) or a set of user biometric data (e.g., information input by the interface user). For instance, a project leader may input preferred meeting time slots. As another example, an athlete may enter their dietary intake (e.g., food eaten) for a specific day.

Environment module 587 relates to a setting or context for management of the set of shared tasks. In embodiments, the context can include a meeting in a corporate environment (e.g., a project gathering, a shareholder meeting, a developer scrum). In embodiments, the context may include a standardized test in an educational environment (e.g., a college admissions exam, a physical fitness test, a test of basic skills). In embodiments, the context can include an appointment in a healthcare environment (e.g., a routine physical examination, an oncology-related treatment, a physical therapy session). In embodiments, the context may include an event in an athletics environment (e.g., a group of sports practices, a personal training appointment, a tournament game/match schedule). In embodiments, the context can include an operator in a travel environment (e.g., an aircraft pilot schedule, a semi-truck driver plan, a car pool arrangement). In embodiments, the context may include a mission in a non-civilian environment (e.g., a reconnaissance timeline).

User schedule module 589 may include considering schedules of each user. Accordingly, using a first current schedule of the first user and a second current schedule of the second user, a set of candidate temporal periods can be computed. The set of candidate temporal periods may have both the first and second users unscheduled according to the first and second current schedules (e.g., so as to facilitate a potential meeting/appointment/event). In response to computing the set of candidate temporal periods, the set of temporal periods may be selected from the set of candidate temporal periods.

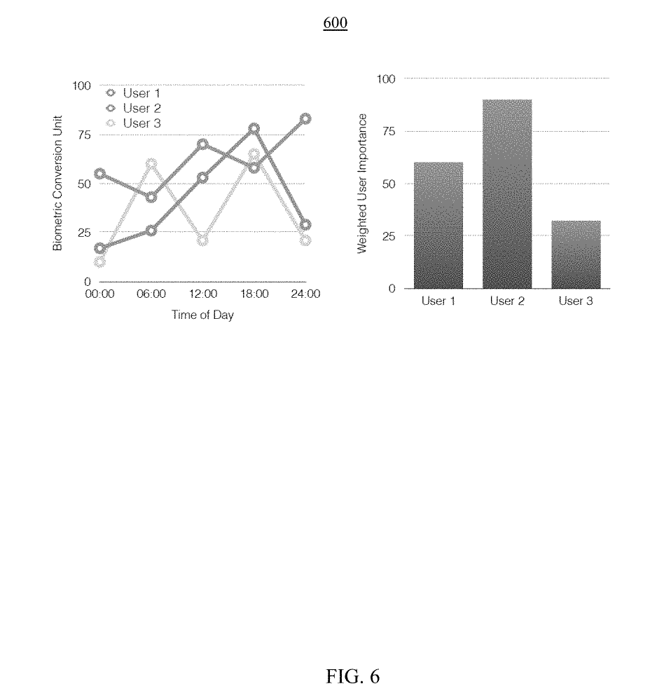

FIG. 6 illustrates example graphs 600 for managing a set of shared tasks according to embodiments. A function of biometric data for a group of users (e.g., biometric conversion unit which may be a normalized unit) and associated weighted user importance may be utilized to determine a schedule. Consider the example that follows. Inputs may include a biometric conversion unit (BCU) which can have a normalized biometric converted data of a user over time, a weight which can have a scale of a user's importance for meeting, and identified free time which may relate to a user's schedule at a given time. An output may include a time (e.g., time for a meeting within certain bounds). In embodiments, the BCU may exceed a threshold for more highly weighted users. BCU may be a normalized biometric score that can be a function of one or more biometric factors (e.g., stress and sleeping can be combined into a single score). Accordingly, the function can assign an importance weight to each BCU.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for managing a set of shared tasks, the method comprising:
detecting a first set of biometric data which indicates a performance factor for a first user;
detecting a second set of biometric data which indicates the performance factor for a second user;
determining, using the first and second sets of biometric data which indicate the performance factor for the first and second users, a set of temporal periods for the first and second users to carry-out the set of shared tasks; and
selecting, with respect to carrying-out the set of shared tasks by the first and second users, the set of temporal periods.

2. The method of claim 1, wherein the first user has a first performance factor value for the performance factor and the second user has a second performance factor value for the performance factor, further comprising:
analyzing the set of shared tasks to identify a set of criteria which favors productivity for the first and second performance factor values; and
ascertaining, in response to analyzing the set of shared tasks, the performance factor based on the set of criteria.

3. The method of claim 2, further comprising:
weighting, based on an attribute value of the first user exceeding the attribute value of the second user, the first and second performance factor values, wherein a first difference between a weighted first performance factor value and the first performance factor value exceeds a second difference between a weighted second performance factor value and the second performance factor value.

4. The method of claim 1, wherein the performance factor is selected from a group consisting of at least one of: a productivity factor, a stress factor, a dietary factor, a sleep factor, a shift factor, an alertness factor, a focus factor, a lactate factor, or a team goal factor.

5. The method of claim 1, further comprising:
receiving, in response to determining the set of temporal periods, a dynamic update; and
changing, based on the dynamic update, the set of temporal periods.

6. The method of claim 5, wherein the dynamic update includes a selection from a group consisting of at least one of:
a biometric data update to at least one of the first set of biometric data or the second set of biometric data,
a user update which adds a new user or removes an existing user, or
a candidate temporal period update which adds or removes a candidate temporal period from which to select the set of temporal periods.

7. The method of claim 1, further comprising:
providing a user interface to allow an interface user to supply information including biometric data, suggested meeting times, and prediction rules; and
determining, in response to the interface user utilizing the user interface, the set of temporal periods using the supplied information.

8. The method of claim 1, further comprising:
collecting, using a first electronic wearable device, the first set of biometric data for the first user;
collecting, using a second electronic wearable device, the second set of biometric data for the second user; and
storing, in a shared pool of configurable computing resources having both a first physical compute node and a second physical compute node, the second set of biometric data on the second physical compute node which is physically separate from the first set of biometric data on the first physical compute node.

9. The method of claim 1, further comprising:
calculating, based on a first user profile data and the set of shared tasks, a weighted first user value for carrying-out the set of shared tasks;
calculating, based on a second user profile data and the set of shared tasks, a weighted second user value for carrying-out the set of shared tasks; and
determining, in response to calculating the weighted first and second user values, the set of temporal periods using both the weighted first user value with respect to the first set of biometric data and the weighted second user value with respect to the second set of biometric data.

10. The method of claim 1, further comprising:
monitoring, in response to determining the set of temporal periods, the first user to collect a first dynamic update to the first set of biometric data;
monitoring, in response to determining the set of temporal periods, the second user to collect a second dynamic update to the second set of biometric data;
evaluating, using on the first and second dynamic updates, the set of temporal periods with respect to a candidate temporal period which is indicated by at least one of the first dynamic update or the second dynamic update; and
selecting, with respect to carrying-out the set of shared tasks by the first and second users, the candidate temporal period.

11. The method of claim 1, further comprising:
computing, using the first and second sets of biometric data which indicate the performance factor for the first and second users, a set of candidate temporal periods; and
providing, for selection by an interface user, the set of candidate temporal periods.

12. The method of claim 1, further comprising:
monitoring, in response to determining the set of temporal periods, a group of users which includes the first and second users to identify a user update to the group of users, wherein the user update includes at least one of adding a new user or removing an existing user;
evaluating, based on the user update, the set of temporal periods with respect to a candidate temporal period which is indicated by the user update; and
selecting, with respect to carrying-out the set of shared tasks, the candidate temporal period.

13. The method of claim 1, further comprising:
providing, for selection by an interface user in response to determining the set of temporal periods, the set of temporal periods which is arranged based on an expected productivity score that relates to both the first and second sets of biometric data and the first and second users.

14. The method of claim 1, wherein detecting the first set of biometric data which indicates the performance factor for the first user includes:
sensing a disconnection with respect to a dynamic connection related to a first set of dynamic biometric data for the first user; and
receiving, from a shared pool of configurable computing resources in response to sensing the disconnection, at least one of: a first set of historical biometric data for the first user, or a first set of predicted biometric data for the first user.

15. The method of claim 1, further comprising:
receiving, from an interface user via a user interface, a set of user data which includes at least one of: a set of preferred temporal periods, or a set of user biometric data.

16. The method of claim 1, wherein the set of shared tasks includes a selection from a group consisting of at least one of:
a meeting in a corporate environment,
a standardized test in an educational environment,
an appointment in a healthcare environment,
an event in an athletics environment,
an operator in a travel environment, or
a mission in a non-civilian environment.

17. The method of claim 1, further comprising:
computing, using a first current schedule of the first user and a second current schedule of the second user, a set of candidate temporal periods which have both the first and second users unscheduled according to the first and second current schedules; and
selecting, in response to computing the set of candidate temporal periods, the set of temporal periods from the set of candidate temporal periods.

18. A system for managing a set of shared tasks, the system comprising:
a memory having a set of computer readable computer instructions, and
a processor for executing the set of computer readable instructions, the set of computer readable instructions including:
detecting a first set of biometric data which indicates a performance factor for a first user;
detecting a second set of biometric data which indicates the performance factor for a second user;
determining, using the first and second sets of biometric data which indicate the performance factor for the first and second users, a set of temporal periods for the first and second users to carry-out the set of shared tasks; and
selecting, with respect to carrying-out the set of shared tasks by the first and second users, the set of temporal periods.

19. A computer program product for managing a set of shared tasks, the computer program product comprising a computer readable storage medium having program instructions embodied therewith, wherein the computer readable storage medium is not a transitory signal per se, the program instructions executable by a processor to cause the processor to perform a method comprising:
detecting a first set of biometric data which indicates a performance factor for a first user;
detecting a second set of biometric data which indicates the performance factor for a second user;
determining, using the first and second sets of biometric data which indicate the performance factor for the first and second users, a set of temporal periods for the first and second users to carry-out the set of shared tasks; and
selecting, with respect to carrying-out the set of shared tasks by the first and second users, the set of temporal periods.

20. The computer program product of claim 19, wherein at least one of:
the program instructions are stored in a computer readable storage medium in a data processing system, and wherein the program instructions were downloaded over a network from a remote data processing system; or
the program instructions are stored in a computer readable storage medium in a server data processing system, and wherein the program instructions are downloaded over a network to a remote data processing system for use in a computer readable storage medium with the remote data processing system.
